(19) United States
(12) Patent Application Publication
(10) Pub. No.: US 2024/0238763 A1
(43) Pub. Date: Jul. 18, 2024

(54) PREPARATION METHOD FOR LA1-XMN1+XO3

(71) Applicant: Tsinghua University, Beijing (CN)

(72) Inventors: Wenzhe SI, Beijing (CN); Yun DING, Beijing (CN); Yue PENG, Beijing (CN); Jianjun CHEN, Beijing (CN); Yongliang MA, Beijing (CN); Junhua LI, Beijing (CN)

(21) Appl. No.: 18/689,831

(22) PCT Filed: Jan. 14, 2022
(86) PCT No.: PCT/CN2022/072044

§ 371 Date: Mar. 6, 2024

(30) Foreign Application Priority Data
Sep. 7, 2021 (CN) 202111043665.7

(51) Int. Cl. B01J 23/34; B01D 53/86; B01J 23/00; B01J 37/00; B01J 37/04; B01J 37/08

(52) U.S. Cl. CPC B01J 23/34; B01D 53/8668; B01J 23/002; B01J 37/0018; B01J 37/04; B01J 37/088; B01D 2255/2063; B01D 2255/2073; B01D 2255/402; B01D 2257/708

(57) ABSTRACT

Provided in the present disclosure is a preparation method for a La₁₋ₓMn₁₊ₓO₃ catalyst, comprising the steps: dissolving a lanthanum salt, a manganese salt, and a nonionic surfactant in solvent to obtain a precursor solution; drying the precursor solution to obtain a viscous solid; calcining the viscous solid to obtain a La₁₋ₓMn₁₊ₓO₃ catalyst, wherein 0≤x<1. The preparation method for a La₁₋ₓMn₁₊ₓO₃ catalyst of the present disclosure is simple and easily performed, raw materials are easy to obtain, the operation is convenient, and the catalyst is suitable for mass production. Further, the La₁₋ₓMn₁₊ₓO₃ catalyst prepared in the present disclosure has excellent performance in catalyzing oxidation of volatile organic compounds.

### TECHNICAL FIELD

The present disclosure relates to a preparation method for La₁₋ₓMn₁₊ₓO₃, in particular to a preparation method for a catalyst La₁₋ₓMn₁₊ₓO₃ applied in the catalytic oxidation of volatile organic compounds, which belongs to the technical field of air pollution control.

### BACKGROUND

Volatile organic compounds (VOCs) are one of the main air pollutants nowadays and are major precursors for the tropospheric secondary pollutant ozone and secondary organic aerosol (SOA). Volatile organic compounds are air pollutants that can undergo photochemical reactions with the atmosphere, and their representative substances are toluene, xylene, ethyl acetate, etc. Some of volatile organic compounds will also cause harm to human health, environment, etc. This is because the large amount of volatile organic compounds released in the environment will undergo reactions that contribute to the generation of photochemical smog and greenhouse effect and the like, and the particles and ozone in the photochemical smog will seriously affect the immune system, respiratory system, reproductive system and the like and may cause, in the worst cases, health problems such as cancer and mutations.

At present, the means to control VOCs emissions are mainly divided into two categories. One is to recycle VOCs by physical methods, such as activated carbon adsorption and condensation recovery and the like; and the other is to oxidize and decompose VOCs into non-toxic or low-toxic substances by destructive methods. Among them, the catalytic oxidation method has attracted much attention because it produces no secondary pollution, has a high removal rate, and requires a low reaction temperature.

There are two major categories of commercial catalysts: precious metal catalysts and non-precious metal catalysts. Perovskite catalysts have become the focus of researchers because of their advantages in thermal stability, chemical stability, and structural stability. Perovskite-type metal oxides have been extensively studied and applied in various fields in the past few decades due to their compositional and structural variability, which enables them to possess different physical and chemical properties (such as redox behavior, oxygen mobility, and electronic and ionic conductivity). It is well known that the catalytic activity of perovskite-type metal oxides is related to their physical and chemical properties, including morphology, specific surface area, pore structure, and oxygen non-stoichiometry.

In recent years, various methods for synthesizing perovskite-type metal oxides (a soft-template method, a hydrothermal method, a combustion method, a sol-gel method, a coprecipitation method, a molten salt method, etc.) have been reported to improve their physical and chemical properties and thus improve their catalytic activity. However, the reaction temperature for catalytic oxidation of toluene by conventionally prepared perovskite-type metal oxides is 300° C. or higher, which is higher than the reaction temperatures of precious metal catalysts. Therefore, how to reduce the reaction temperature for catalytic oxidation of toluene by a perovskite-type catalyst is a technical difficulty nowadays.

Cited Literature 1 adopts the citrate complexing sol-gel method to prepare LaMnO₃, which is observed to exhibit a good catalytic activity for all oxidation reactions of VOCs (acetone, isopropanol, and benzene). Cited Literature 2 adopts the citrate complexing-hydrothermal synthesis method to prepare polycrystalline cubic or rhombic perovskite-type oxide La₁₋ₓSrₓMO_{3-δ} (M=Co, Mn; x=0, 0.4) as a spherical nanoparticle, which has a catalytic activity for the oxidation reactions of typical VOCs (ethyl acetate and toluene). Nevertheless, Cited Literature 1 requires the use of citric acid to prepare the catalyst, which has a lower catalytic activity, and the reaction temperature at which the perovskite-type metal oxide catalyzes oxidation of toluene is 300° C. or higher. Cited Literature 2 not only requires the use of citric acid to prepare the catalyst, but also requires preparation of the crystal phase, so its preparation method is too complicated, which is not conducive to promotion, and the reaction temperature at which the perovskite-type metal oxide catalyzes oxidation of toluene is also 300° C. or higher.

Cited Literature 3 discloses a perovskite-type composite metal oxide catalyst and a preparation method therefor, wherein the perovskite-type composite metal oxide catalyst has a MO_{y}/LaMO₃ structure. The preparation method for this catalyst comprises: (1) mixing raw materials at a molar ratio of La:M=1:0.8 to 1:1.2 and loading the mixture on a carrier by one of the sol-gel method, the impregnation method or the coprecipitation method; (2) mixing deionized water, acid, and potassium permanganate in proportions to prepare acidic potassium permanganate solutions with different concentrations; (3) then impregnating the LaMO₃ perovskite-type material prepared in step (1) in the acidic potassium permanganate solution; and (4) washing the material obtained in step (3) with distilled water or deionized water and drying the material. The catalyst obtained by the above preparation method can remove toluene, but its preparation method is too complicated and its components are very complex.

### CITED LITERATURES

Cited Literature 1: J. J. Urban et al., NanoLetters, 2004, 4, 1547-1550
Cited Literature 2: J. R. Niu et al., Catalysis Today 2007, 126, 420
Cited Literature 3: CN109364915A

### SUMMARY

### Technical Problem

In view of the technical problems existing in the prior art, the present disclosure provides a method for preparing a La₁₋ₓMn₁₊ₓO₃ catalyst at first. This preparation method is simple and practicable, easy to access raw materials, and easy to operate.

The La₁₋ₓMn₁₊ₓO₃ catalysts obtained by the preparation method of the present disclosure can be applied in the catalytic oxidation of volatile organic compounds.

### Solution to Problem

[1]. A method for preparing a La₁₋ₓMn₁₊ₓO₃ catalyst, comprising the following steps:
dissolving a lanthanum salt, a manganese salt, and a nonionic surfactant into a solvent to obtain a precursor solution;
drying the precursor solution to obtain a viscous solid; and
calcining the viscous solid to obtain the La₁₋ₓMn₁₊ₓO₃ catalyst;
wherein 0≤x<1.

[2]. The preparation method according to [1] described above, wherein a method for preparing the precursor solution comprises the following steps:
dissolving the lanthanum salt and the manganese salt into a first solvent to obtain a first mixed solution;
dissolving the nonionic surfactant into a second solvent to obtain a second mixed solution; and
mixing the first mixed solution and the second mixed solution to obtain the precursor solution; wherein the first solvent is different from the second solvent.

[3]. The preparation method according to [2] described above, wherein the first solvent is water; and/or the second solvent is an alcohol solvent; preferably, the alcohol solvent includes one or a combination of two or more of ethanol, n-propanol, isopropanol, n-pentanol, isopentanol, n-hexanol, and isohexanediol.

[4]. The preparation method according to [1] to [3] described above, wherein the lanthanum salt is one or a combination of two or more of lanthanum nitrate, lanthanum sulfate, lanthanum acetate or lanthanum chloride; and the manganese salt is one or a combination of two or more of manganese nitrate, manganese sulfate, manganese acetate, and manganese chloride.

[5]. The preparation method according to [1] to [4] described above, wherein the nonionic surfactant includes one or a combination of two or more of alkylolamide, alkylamine ethoxylates, and alkylamine.

[6]. The preparation method according to [1] to [5] described above, wherein a molar ratio of the manganese salt to the nonionic surfactant is (1 to 3):2.

[7]. The preparation method according to [1] to [6] described above, wherein a temperature for the drying is 60° C. to 80° C., and drying time is 6 to 8 h.

[8]. The preparation method according to [1] to [7] described above, wherein the calcining is carried out by heating to 500° C. to 700° C. under a condition where a heating rate is 1 to 5° C./min.

[9]. The preparation method according to [1] to [8] described above, wherein calcining time is 4 to 6 h; and/or the calcining is carried out in an air atmosphere.

[10]. Use of a La₁₋ₓMn₁₊ₓO₃ catalyst obtained by the preparation method according to [1] to [9] described above in the catalytic oxidation of volatile organic compounds, preferably in the catalytic oxidation of toluene-based compounds.

### Advantageous Effects of the Invention

The preparation method for the La₁₋ₓMn₁₊ₓO₃ catalyst of the present disclosure is simple and practicable, easy to access raw materials, easy to operate, and suitable for mass production.

Furthermore, the La₁₋ₓMn₁₊ₓO₃ catalysts prepared in the present disclosure have excellent properties in catalyzing oxidation of volatile organic compounds.

### BRIEF DESCRIPTION OF THE DRAWINGS

FIG. 1 is an XRD comparison diagram for the LaMnO₃ catalyst prepared in Example 1 of the present disclosure and the LaMnO₃ catalyst prepared in Comparative Example 1.

FIG. 2 is a diagram for the reaction performance of the LaMnO₃ catalyst in Example 1 of the present disclosure.

FIG. 3 is a diagram for the reaction performance of the LaMnO₃ catalyst prepared in Comparative Example 1.

FIG. 4 is a diagram for the reaction performance of the LaMnO₃ catalyst prepared in Comparative Example 2.

### DETAILED DESCRIPTION

The present disclosure will be described in detail below. The technical features disclosed below are described based on the representative embodiments and specific examples of the present disclosure, but the present disclosure is not limited to these embodiments and specific examples. It is to be noted that:

The numerical range represented by “numerical value A to numerical value B” used in the present specification refers to the range including the endpoint values A and B.

In the present specification, the term “more”, “multiple”, “a plurality of” or the like means a numerical value of two or more, unless otherwise stated.

In the present specification, the term “basically”, “largely” or “substantially” means an error of 5% or less, or 3% or less or 1% or less than the related perfect or theoretical standard.

In the present specification, “%” always indicates a mass percentage content, unless otherwise specified.

In the present specification, the term “may” involves both the meaning of doing something and the meaning of not doing something.

In the present specification, the term “optional” or “optionally” means that the event or situation described subsequently may or may not occur, and the description includes the situation where the event occurs and the situation where the event does not occur.

Phrases such as “some specific/preferred embodiments”, “other specific/preferred embodiments”, “embodiments” and the like referred to in the present specification mean that particular elements (for example, features, structures, properties and/or characteristics) described in relation to this embodiment are included in at least one of the embodiments described herein, and may or may not exist in other embodiments. Additionally, it should be understood that the elements may be combined in any suitable manner into various embodiments.

The present disclosure firstly provides a method for preparing a La₁₋ₓMn₁₊ₓO₃ catalyst, comprising the following steps:
dissolving a lanthanum salt, a manganese salt, and a nonionic surfactant into a solvent to obtain a precursor solution;
drying the precursor solution to obtain a viscous solid; and
calcining the viscous solid to obtain the La₁₋ₓMn₁₊ₓO₃ catalyst;
wherein 0≤x<1.

The La₁₋ₓMn₁₊ₓO₃ catalyst of the present disclosure is prepared by dissolving a lanthanum salt, a manganese salt, and a nonionic surfactant into a solvent to form a precursor solution, and drying the precursor solution to form a viscous solid; and thereafter obtaining the La₁₋ₓMn₁₊ₓO₃ catalyst under the high-temperature calcination conditions. This preparation method is simple and practicable, easy to access raw materials, and easy to be produced massively, and the prepared La₁₋ₓMn₁₊ₓO₃ catalysts have a high catalytic activity.

The value of x is not particularly limited in the present disclosure, and may be selected as needed. For example, x may be 0, 0.1, 0.3, 0.5, 0.7 or 0.9, etc.

The way to dissolve the lanthanum salt, the manganese salt, and the nonionic surfactant into the solvent is not particularly limited in the present disclosure, and they may be mixed in any feasible way. As for the solvent, the present disclosure may use an alcohols solvent, and specifically, it may be an aqueous alcohols solvent with a certain concentration. The concentration of the aqueous alcohols solvent is not particularly limited in the present disclosure, and may be selected as needed. Furthermore, the alcohols solvent of the present disclosure may include one or a combination of two or more of ethanol, n-propanol, isopropanol, n-pentanol, isopentanol, n-hexanol, isohexanediol, etc.

Furthermore, in some specific embodiments, the preparation method for the precursor solution comprises the following steps:
dissolving the lanthanum salt and the manganese salt into a first solvent to obtain a first mixed solution;
dissolving the nonionic surfactant into a second solvent to obtain a second mixed solution; and
mixing the first mixed solution and the second mixed solution to obtain the precursor solution; wherein the first solvent is different from the second solvent.

In some specific embodiments, after the lanthanum salt and the manganese salt are dissolved into the first solvent, methods such as stirring, ultrasound and the like may be employed to make the lanthanum salt and the manganese salt dissolved quickly and dispersed evenly. After the nonionic surfactant is dissolved in the second solvent, methods such as stirring, ultrasound and the like may also be employed to make the nonionic surfactant dissolved quickly and dispersed evenly.

Furthermore, after the first mixed solution is mixed with the second mixed solution, methods such as stirring, ultrasound and the like may also be adopted to make them mixed evenly. Stirring is preferably used to obtain a precursor solution. Specifically, the stirring time may be 30 to 40 min, e.g., 32 min, 35 min, 37 min or 39 min, etc.

In some specific embodiments, the first solvent of the present disclosure is water; and/or the second solvent of the present disclosure is an alcohol solvent. In view of the catalytic activity of the La₁₋ₓMn₁₊ₓO₃ catalyst, it is preferred that the alcohols solvent of the present disclosure includes one or a combination of two or more of ethanol, n-propanol, isopropanol, n-pentanol, isopentanol, n-hexanol, isohexanediol, etc. The amount of the alcohols solvent is not particularly limited in the present disclosure as long as it can dissolve the nonionic surfactant.

The lanthanum salt and the manganese salt are not particularly limited in the present disclosure, and may be some lanthanum salts and manganese salts commonly used in the art. In some specific embodiments, the lanthanum salt may be one or a combination of two or more of a nitrate salt of lanthanum, a nitrite salt of lanthanum, a sulfate salt of lanthanum, a sulfite salt of lanthanum, an acetate salt of lanthanum, or a chloride salt of lanthanum, etc. For example, the lanthanum salt may be one or a combination of two or more of lanthanum nitrate, lanthanum sulfate, lanthanum acetate or lanthanum chloride, etc. The manganese salt is one or a combination of two or more of a nitrate salt of manganese, a nitrite salt of manganese, a sulfate salt of manganese, a sulfite salt of manganese, an acetate salt of manganese, or a chloride salt of manganese, etc.

The nonionic surfactant is not particularly limited in the present disclosure as long as it can fulfill the functions of the present disclosure. Furthermore, it is preferred in the present disclosure to use alkylolamide, alkylamine ethoxylates or alkylamine as a nonionic surfactant, such that the catalytic activity of the La₁₋ₓMn₁₊ₓO₃ catalyst can be further improved.

As for alkylolamide, its structural formula may be represented as:

R₁CONHₘ(R₂OH)₂₋ₘ

wherein R₁ is hydrocarbyl having 8 carbon atoms or more, preferably hydrocarbyl having 8 to 20 carbon atoms; R₂ is alkyl having 6 carbon atoms or less, preferably alkyl having 1 to 4 carbon atoms; m is 0 or 1.

In general, the hydrocarbyl may be alkyl, alkenyl, etc.

Specifically, the R₁ may be one of cocoyl, dodecyl, etc., and the R₂ may be one of methyl, ethyl, propyl, isopropyl, etc.

For example, the alkylolamide may be one or a combination of two or more of coconut diethanolamide, coconut oil monoethanolamide, dodecyl diethanolamide, dodecyl monoisopropanolamide, etc.

As for alkylamine ethoxylates, its structural formula may be as follows:

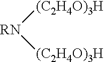

wherein R is alkyl having 8 carbon atoms or more, preferably alkyl having 8 to 20 carbon atoms; x and y may be a natural number of 5 to 50, preferably a natural number of 10 to 40.

Specifically, the R may be one of cocoyl, dodecyl, octadecyl, etc.

For example, the alkylamine ethoxylates may be one or a combination of two or more of coconut amine ethoxylates, dodecylamine ethoxylates, octadecylamine ethoxylates, etc.

As for alkylamine, its structural formula may be as follows:

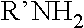

wherein R′ is alkyl having 8 carbon atoms or more, preferably alkyl having 8 to 20 carbon atoms.

Specifically, the R′ may be one of cocoyl, dodecyl, tetradecyl, hexadecyl, octadecyl, etc.

For example, the alkylamine may be one or a combination of two or more of coconut amine, dodecylamine, tetradecylamine, hexadecylamine, octadecylamine, etc.

Additionally, in order to further improve the catalytic activity of the La₁₋ₓMn₁₊ₓO₃ catalyst of the present disclosure, it is preferable not to use hydroxyl-based chelating agents such as citric acid (CA), tartaric acid (TA), gluconic acid (GA) and the like in the present disclosure.

In some specific embodiments, the molar ratio of the manganese salt to the nonionic surfactant is (1 to 3):2. When the molar ratio of the manganese salt to the nonionic surfactant is (1 to 3):2, La₁₋ₓMn₁₊ₓO₃ catalysts with excellent properties can be prepared.

In the present disclosure, the viscous solid is obtained by means of drying. In some specific embodiments, in order to facilitate the preparation of the La₁₋ₓMn₁₊ₓO₃ catalyst, in the drying step, the temperature for the drying is 60° C. to 100° C., e.g., 65° C., 70° C., 75° C., 80° C., 85° C., 90° C., 95° C., etc, and drying time is 6 to 8 h, e.g., 6.5 h, 7 h, 7.5 h, etc.

In the present disclosure, the La₁₋ₓMn₁₊ₓO₃ catalyst is obtained by means of the calcining step. In some specific embodiments, in order to obtain the La₁₋ₓMn₁₊ₓO₃ catalyst with excellent properties, the calcining is carried out by heating to 500° C. to 700° C. at a heating rate of 1 to 5° C./min in the calcining step. calcining time is 4 to 6 h. Specifically, the heating rate may be 1.5° C./min, 2° C./min, 2.5° C./min, 3° C./min, 3.5° C./min, 4° C./min, 4.5° C./min, etc. The temperature for the calcining may be 520° C., 540° C., 560° C., 580° C., 600° C., 620° C., 650° C., 680° C., etc. The time of the calcining is 4.2 h, 4.4 h, 4.6 h, 4.8 h, 5 h, 5.2 h, 5.4 h, 5.6 h, 5.8 h, etc. Furthermore, in the present disclosure, the calcining may be carried out in an air atmosphere.

The present disclosure provides use of a La₁₋ₓMn₁₊ₓO₃ catalyst obtained by the preparation method according to the present disclosure in the catalytic oxidation of volatile organic compounds, preferably in the catalytic oxidation of toluene-based compounds.

### EXAMPLES

The embodiments of the present disclosure will be described in detail below with reference to the examples. However, a person skilled in the art will appreciate that the following examples are only intended to illustrate the present disclosure, and shall not be regarded as limiting the scope of the present disclosure. Where specific conditions are not indicated in the examples, conventional conditions or the conditions recommended by the manufacturer shall be followed. Where the manufacturers of the reagents or instruments used are not indicated, all of them are commercially-available conventional products.

### Example 1

### Preparation of LaMnO₃-1 Catalyst

Firstly, 4 mmol of lanthanum nitrate and 4 mmol of manganese nitrate were weighed and dissolved in 10 mL of aqueous solution to form a clear solution A while stirring. Next, 8 mmol of hexadecylamine was weighed and dissolved in 50 mL of ethanol solution to form a clear solution B while stirring. The clear solution A was added dropwise into the clear solution B, and stirred for 30 min to form a mixed solution C (i.e. the precursor solution). Afterwards, the mixed solution was dried in a drying oven at 65° C. for 6 h to obtain a viscous solid. Finally, the viscous solid was heated to 600° C. at a heating rate of 5° C./min in an air atmosphere and calcined for 5 h to thereby obtain LaMnO₃.

### Example 2

Firstly, 4 mmol of lanthanum nitrate and 4 mmol of manganese nitrate were weighed and dissolved in 10 mL of aqueous solution to form a clear solution A while stirring. Next, 8 mmol of hexadecylamine was weighed and dissolved in 50 mL of isopropanol solution to form a clear solution B while stirring. The clear solution A was added dropwise into the clear solution B, and stirred for 30 min to form a mixed solution C (i.e. the precursor solution). Afterwards, the mixed solution was dried in a drying oven at 65° C. for 6 h to obtain a viscous solid. Finally, the viscous solid was heated to 600° C. at a heating rate of 5° C./min in an air atmosphere and calcined for 5 h to thereby obtain LaMnO₃.

### Example 3

Firstly, 4 mmol of lanthanum nitrate and 4 mmol of manganese nitrate were weighed and dissolved in 10 mL of aqueous solution to form a clear solution A while stirring. Next, 8 mmol of hexadecylamine was weighed and dissolved in 50 mL of n-hexanol solution to form a clear solution B while stirring. The clear solution A was added dropwise into the clear solution B, and stirred for 30 min to form a mixed solution C (i.e. the precursor solution). Afterwards, the mixed solution was dried in a drying oven at 65° C. for 6 h to obtain a viscous solid. Finally, the viscous solid was heated to 600° C. at a heating rate of 5° C./min in an air atmosphere and calcined for 5 h to thereby obtain LaMnO₃.

### Comparative Example 1

### Preparation of LaMnO₃ Catalyst

Firstly, 4 mmol of lanthanum nitrate and 4 mmol of manganese nitrate were weighed and dissolved in 10 mL of aqueous solution to form a clear solution A while stirring. Next, 8 mmol of citric acid was weighed and dissolved in 50 mL of ethanol solution to form a clear solution B while stirring. The clear solution A was added dropwise into the clear solution B, and stirred for 30 min to form a mixed solution C. The stirring was continued until the solution became a sol-gel. Afterwards, the sol-gel was foamed in a drying oven at 70° C. Finally, the resultant was heated to 700° C. at a heating rate of 5° C./min in an air atmosphere and calcined for 5 h to thereby obtain LaMnO₃.

### Comparative Example 2

Firstly, 8 mmol of ethylenediamine was weighed and dissolved in 50 mL of ethanol solution, and stirred and mixed thoroughly. Next, 4 mmol of lanthanum nitrate and 4 mmol of manganese nitrate were added to the above solution, continued to be stirred for 1 h, and transferred to an evaporating dish. Afterwards, the evaporating dish was dried in a drying oven at 70° C. for 18 h. Finally, the resultant was calcined in a muffle furnace at 750° C. for 2.5 h in an air atmosphere to thereby obtain LaMnO₃.

### Performance Tests

### 1. XRD Test

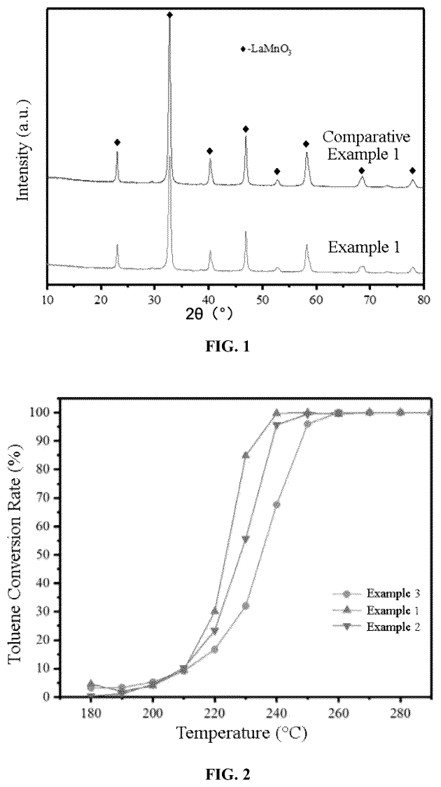

FIG. 1 showed the XRD diagram for the LaMnO₃ catalyst in Example 1 of the present disclosure and the LaMnO₃ catalyst prepared in Comparative Example 1. The XRD diagrams for the LaMnO₃ catalysts in Examples 2 and 3 were basically the same as that in Example 1. As could be seen from FIG. 1, the LaMnO₃ catalysts of the present disclosure contained the active ingredient LaMnO₃, and characteristic peaks of cubic LaMnO₃ (JCPDS card No. 75-440) always appeared in the drawing. With this synthesis method, LaMnO₃ with a better crystal form could be successfully synthesized without the formation of other metal oxides.

### 2. Experiment on Catalytic Oxidation of Toluene

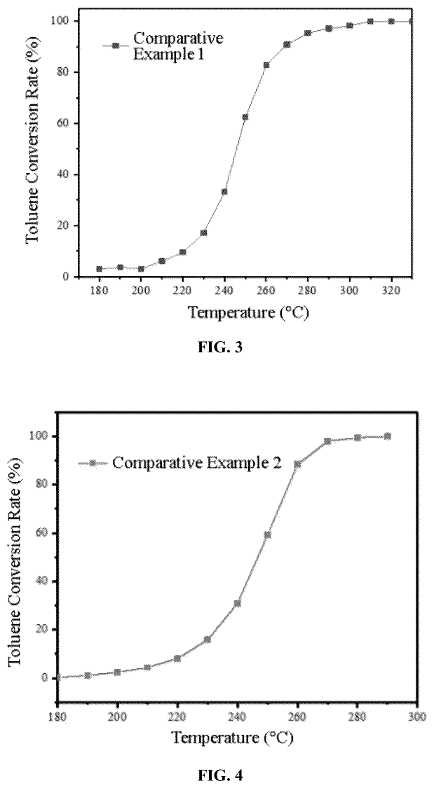

0.1 g of each of the LaMnO₃ catalysts in Examples 1 to 3 and Comparative Examples 1 and 2 were weighed for the experiment, separately. Specifically, the LaMnO₃ catalysts in Examples 1 to 3 and Comparative Examples 1 and 2 were placed in continuous-flow fixed-bed reactors, respectively. The components of the reactant gas included, by mass %, 1000 ppm of toluene. The flow rate of the reactant gas was 100 mL/min, and the volume space velocity of the reactant gas was 60000 mL/(gh). The corresponding toluene conversion rates by the catalysts at different temperatures were tested at the reaction temperature of 150° C. to 300° C., respectively. The results were as shown in FIGS. 2, 3, and 4.

As could be appreciated from FIGS. 2, 3, and 4, T₉₀% at which the LaMnO₃ catalysts of the present disclosure catalyzed toluene was 250° C. or lower, while the reaction performance diagram for the LaMnO₃ catalyst prepared by the citrate method in Comparative Example 1 showed that T₉₀% at which the LaMnO₃ catalyst catalyzed oxidation of toluene was about 272° C., and the reaction performance diagram for the LaMnO₃ catalyst prepared by the ethylenediamine chelating agent in Comparative Example 2 showed that T₉₀% at which the LaMnO₃ catalyst catalyzed oxidation of toluene was about 260° C.

As shown above, the LaMnO₃ catalysts of the present disclosure contained LaMnO₃ as an active ingredient, and could catalyze oxidation of toluene. Moreover, as could be appreciated from FIGS. 2, 3, and 4, the LaMnO₃ catalysts prepared by the preparation method of the present disclosure had excellent performance in catalyzing oxidation of toluene, as compared to the LaMnO₃ catalysts prepared by the conventional citrate sol-gel method or ethylenediamine chelating agent method. The preparation method of the present disclosure is simple and practicable and easy to operate.

### INDUSTRIAL APPLICABILITY

The LaMnO₃ catalysts provided in the present disclosure can be industrially prepared and are applied for catalytic oxidation of volatile organic compounds, in particular catalytic oxidation of toluene-based compounds.

Although the examples of the present disclosure have been described above, the above descriptions are exemplary, but not exhaustive; and the disclosed examples are not limiting. A number of modifications and variations may occur to a person skilled in the art without departing from the scopes and spirits of the described examples. The terms in the present disclosure are selected to provide the best explanation on the principles and practical applications of the examples and the technical improvements to the arts on market, or to make the examples described herein understandable to a person skilled in the art.

What is claimed is:

1. A method for preparing a La₁₋ₓMn₁₊ₓO₃ catalyst, comprising the following steps:
dissolving a lanthanum salt, a manganese salt, and a nonionic surfactant into a solvent to obtain a precursor solution;
drying the precursor solution to obtain a viscous solid; and
calcining the viscous solid to obtain the La₁₋ₓMn₁₊ₓO₃ catalyst;
wherein 0≤x<1.

2. The preparation method according to claim 1, wherein a method for preparing the precursor solution comprises the following steps:
dissolving the lanthanum salt and the manganese salt into a first solvent to obtain a first mixed solution;
dissolving the nonionic surfactant into a second solvent to obtain a second mixed solution; and
mixing the first mixed solution and the second mixed solution to obtain the precursor solution;
wherein the first solvent is different from the second solvent.

3. The preparation method according to claim 2, wherein the first solvent is water; and/or the second solvent is an alcohol solvent.

4. The preparation method according to claim 1, wherein the lanthanum salt is one or a combination of two or more of lanthanum nitrate, lanthanum sulfate, lanthanum acetate or lanthanum chloride; and the manganese salt is one or a combination of two or more of manganese nitrate, manganese sulfate, manganese acetate, and manganese chloride.

5. The preparation method according to claim 1, wherein the nonionic surfactant includes one or a combination of two or more of alkylolamide, alkylamine ethoxylates, and alkylamine.

6. The preparation method according to claim 1, wherein a molar ratio of the manganese salt to the nonionic surfactant is (1 to 3):2.

7. The preparation method according to any one of claim 1, wherein a temperature for the drying is 60° C. to 100° C., and drying time is 6 to 8 h.

8. The preparation method according to claim 1, wherein the calcining is carried out by heating to 500° C. to 700° C. under a condition where a heating rate is 1 to 5° C./min.

9. The preparation method according to claim 1, wherein calcining time is 4 to 6 h; and/or the calcining is carried out in an air atmosphere.

10. A method of catalytic oxidation of volatile organic compounds, wherein the method comprises utilizing a La₁₋ₓMn₁₊ₓO₃ catalyst prepared by the preparation method according to claim 1.

11. The preparation method according to claim 3, wherein the alcohol solvent includes one or a combination of two or more of ethanol, n-propanol, isopropanol, n-pentanol, isopentanol, n-hexanol, and isohexanediol.

12. The method according to claim 10, wherein the volatile organic compounds are toluene-based compounds.
